(19) United States
(12) Patent Application Publication
(10) Pub. No.: US 2005/0028558 A1
(43) Pub. Date: Feb. 10, 2005

(54) Process for producing glass molded lens

(75) Inventor: Kouichi Sato, Nishitokyo-shi (JP)

Correspondence Address: NIXON & VANDERHYE, PC, 1100 N GLEBE ROAD, 8TH FLOOR, ARLINGTON, VA, 22201-4714, US

(73) Assignee: Hoya Corporation, Tokyo (JP)

(21) Appl. No.: 10/912,569

(22) Filed: Aug. 6, 2004

(30) Foreign Application Priority Data
Aug. 6, 2003 (JP) 2003-287332

(51) Int. Cl. C03B 23/00

(52) U.S. Cl. 65/32.1

(57) ABSTRACT

Provided is a process for producing a small-diameter glass molded lens that is made of a high-refractivity optical glass and having a small central thickness and a biconvex form, without causing cracking or breaking of the lens, and the process includes the steps of introducing a glass material made of an optical glass having a refractive index nd of 1.70 or more and provided with a mold release functional film on a surface into a mold and press-molding the glass material to obtain the glass molded lens, the glass material having a surface free energy of 55 mJ/m² or less when it is press-molded.

### TECHNICAL FIELD

The present invention relates to a process for producing a glass molded lens (glass lens produced by molding). More specifically, it relates to a process for producing an aspherical glass molded lens that is formed of an optical glass having a high refractive index and which has a biconvex form having a relatively small central thickness.

A glass molded lens obtained according to the present invention is suitable for use in a compact optical device such as a camera, a mobile device, and the like.

### TECHNICAL BACKGROUND

In an optical system for use in an image-sensing device such as a camera, conventionally, an aspherical lens is used in the optical system or the number of lenses is limited for simplification of a lens constitution and attaining weight saving. For example, JP-A-4-46021 discloses a press-molded lens having an aspherical biconvex form, produced by a re-heat press molding.

### DISCLOSURE OF THE INVENTION

In recent years, there are remarkably increasing demands for small-sized portable optical devices typified by a digital camera and a mobile device, and these devices are demanded to realize unconventional downsizing and unconventional weight saving while it can maintain a high image quality as an image-sensing device.

The above downsizing and weight saving of an optical device can be accomplished to some extent by employing aspherical lenses and decreasing the number of lenses in an optical system. For attaining further downsizing, it is required to improve individual lenses for use in the optical system. That is, when lenses having a smaller thickness are used as individual lenses, the optical system can be further downsized. Since, however, the lenses are required to attain predetermined optical performances while they have a smaller thickness, the lenses are required to have a form having a small central thickness and a large curvature radius and are required to have optical performances which conventional lenses have.

The present inventor has therefore devoted his attention to the fact that a higher-refractivity optical glass can give a refractive index equivalent to the refractive index of a conventional optical glass having a large thickness even if the higher-refractivity optical glass has a form having a small central thickness and a large curvature radius.

However, when attempts are made to obtain a biconvex small-thickness lens having a central thickness of approximately 1.2 to 1.8 mm, the circumferential portion of the lens has even smaller thickness, so that the lens (glass-molded product) is greatly liable to undergo cracking or breaking in a press step. Particularly, in the production of an optical lens having a flange-shaped annular flat portion around the optical-function surface of a biconvex lens, the lens is liable to undergo breaking, and the difficulty level of the production thereof is high. Further, the present inventor has made studies and found that the above high-refractivity optical glass has low glass stability, so that it is liable to undergo, particularly, cracking or breaking during its press-molding or releasing a product from a mold. Particularly, concerning a lens made of a high-refractivity optical glass having a refractive index (nd) of 1.70 or more, the difficulty level of press-molding is high due to its glass composition, and when an attempt is made to produce a lens having a small thickness, it extremely easily undergoes breaking.

Under the circumstances, there has not been reported any process for producing an aspherical glass molded lens that is made of a high-refractivity optical glass and that has a biconvex form having a relatively small central thickness.

The present invention has been made in view of the above circumstances, and it is an object of the present invention to provide a process for producing a small-diameter glass molded lens that is made of a high-refractivity optical glass and that has a small central thickness and a biconvex form, without causing cracking or breaking.

Breaking of a lens during press-molding or during the releasing of a product from a mold mainly includes breaking externally caused depending upon an interface between a lens surface and the molding surface of a mold and breaking internally caused by a residual stress or strain inside a lens.

Of the above breakings, the present inventor focused his attention on the externally caused breaking. That is, a small-thickness lens has a relatively large curvature radius and therefore highly tends to adhere to the molding surface of a mold, so that a friction takes place in the interface between the small-thickness lens and the mold. Focusing attention to the above point, the present inventor has found that it is essential to prevent the breaking caused by the above friction. Particularly when a convex lens is produced from a glass material having a mold release functional film on a surface by press molding, a portion corresponding to the circumference of the lens is locally extended to be thinner during the pressing, so that the surface area thereof increases. It is therefore considered that the thickness of the above mold release functional film comes to be insufficient and that the externally caused breaking is liable to occur. The breaking of this type is noticeably liable to take place particularly in a lens having a flange-shaped annular flat portion around the lens.

On the other hand, as a high-refractivity glass, for example, there is known a phosphate-based optical glass having a refractive index nd of 1.70 to 2.0 and an Abbe's number νd of 20 to 28.5 (the above “phosphate-based” means that the main network-forming component is phosphoric acid). However, such an optical glass has low mechanical strength since it mainly contains a considerable amount of phosphate, so that it is liable to undergo breaking. It is therefore difficult to produce the same by press molding although it is a glass remarkably advantageous in optical functions.

As another high-refractivity glass, an optical glass having a refractive index nd of 1.75 to 1.85 and an Abbe's number νd of 40 to 55 is available. This optical glass has large contents of components such as La₂O₃, Gd₂O₃, etc., in many cases. However, it is likely to be a glass material having a high softening point, and it is required to heat the glass material at 600° C. or higher for adjusting its viscosity to a viscosity suitable for press molding, which exceeds a viscosity corresponding to its sag temperature Ts. For this reason, a mold release functional film provided on the glass material surface is easily deteriorated, so that a friction takes place in an interface between a mold and a lens, which friction may cause breaking during the production of a lens by molding or during cooling after the molding. Particularly in a process of pre-heating a glass material to a temperature higher than the temperature of a mold, introducing the glass material in a fully softened state into the mold and press-molding it, it has been found that a mold release functional film is deteriorated, so that a lens is liable to break.

The present inventor has made further studies on the basis of the above finding, and as a result, it has been found that cracking and breaking of a lens and surface free energy of a glass material correlate with each other.

The present inventor prepared a glass material from an optical glass having a refractive index nd of 1.82114, an Abbe's number νd of 24.1, a glass transition temperature Tg of 475° C. and a sag temperature Ts of 525° C. (corresponding to glass I shown in Table 2 to be described later), formed a carbon-containing film on the surface of the glass material and measured it for a surface free energy immediately after the formation of the carbon-containing film. In this case, the glass material showed a surface free energy of 45 mJ/m². The glass material was heated at 590° C. for 220 seconds and then measured to show that the surface free energy at room temperature increased to 65 mJ/m². The present inventor has made studies on a coorelationship between the surface free energy of a glass material and the occurrence of breaking during press-molding, and it has been found that when a glass material has a surface free energy of 55 mJ/m² or less when it is press-molded, no lens undergoes breaking even if a lens having a central thickness of 1.2 to 1.8 mm is produced by press-molding a high-refractivity glass that is easily breakable.

The present inventor has found the following. When a glass material having a surface free energy of 55 mJ/m² or less in press-molding is press-molded by a press-molding method, externally caused breaking can be prevented, and desired optical lenses can be easily produced. The present invention has been accordingly completed.

That is, according to the present invention, there are provided;
(1) a process for producing a glass molded lens, which comprises the steps of introducing a glass material made of an optical glass having a refractive index nd of 1.70 or more and provided with a mold release functional film on a surface into a mold and press-molding the glass material to obtain the glass molded lens, the glass material having a surface free energy of 55 mJ/m² or less when it is press-molded,
(2) a process as recited in the above (1), wherein the glass material is pre-heated in a non-oxidizing atmosphere up to a temperature corresponding to a viscosity of 10^{6.5} to 10^{8.5} poise as a glass viscosity before the glass material is introduced into the mold,
(3) a process as recited in the above (2), wherein the press-molding is carried out in a non-oxidizing atmosphere in the mold that is heated up to a temperature corresponding to a viscosity of 10^{7.5} to 10^{10.0} poise as a glass viscosity,
(4) a process as recited in the above (1), wherein the optical glass contains at least one member selected from TiO₂, Nb₂O₅ or WO₃ and has a TiO₂, Nb₂O₅ and WO₃ total content of 20 to 45 mol %,
(5) a process as recited in the above (1), wherein the optical glass is a phosphate glass,
(6) a process as recited in the above (1), wherein the optical glass contains at least one member selected from La₂O₃ or Gd₂O₃ and has a La₂O₃ and Gd₂O₃ total content of 12 to 24 mol %,
(7) a process as recited in the above (1), wherein the glass molded lens has a biconvex form having a central thickness of 1.2 to 1.8 mm and has a diameter of 5 to 20 mm after produced by press-molding,
(8) a process as recited in the above (1), wherein the glass molded lens has an annular flat portion in a circumference thereof, and
(9) a process as recited in the above (1), wherein the glass molded lens has a rim thickness of 0.1 to 0.7 mm.

### EFFECT OF THE INVENTION

According to the present invention, there can be produced a small-diameter glass molded lens that is made of a high-refractivity optical glass and that has a biconvex form having a small central thickness, without causing cracking or breaking.

Further, there can be simply produced an aspherical glass molded lens having high surface accuracy and thickness accuracy, having a biconvex form and having a small thickness.

### BRIEF DESCRIPTION OF DRAWINGS

FIG. 1 shows drawings for explaining the biconvex lenses in Examples.

### PREFERRED EMBODIMENTS OF THE INVENTION

The process for producing a glass molded lens, provided by the present invention, comprises the steps of introducing a glass material made of an optical glass having a refractive index nd of 1.70 or more and provided with a mold release functional film on a surface into a mold and press-molding the glass material to obtain the glass molded lens, the glass material having a surface free energy of 55 mJ/m² or less when it is press-molded.

The optical glass for use in the process of the present invention is a high-refractivity optical glass having a refractive index nd of 1.70 or more, preferably 1.70 to 2.0, more preferably 1.75 to 2.0, still more preferably 1.75 to 1.85. Further, the above optical glass is desirably an optical glass having the above refractive index and high dispersion properties represented by an Abbe's number νd of 20 to 28.5 (to be referred to as “optical glass A” hereinafter) or an optical glass having the above refractive index and dispersion properties represented by an Abbe's number νd of 40 to 55 (to be referred to as “optical glass B” hereinafter). When the above optical glass having a high refractive index is used, sufficient optical power can be obtained in a small-sized portable optical device, etc., even if a lens has a small thickness and a large curvature radius.

The optical glass A includes an optical glass containing, as a high-refractivity component, at least one member selected from TiO₂, Nb₂O₅ or WO₃ and having a TiO₂, Nb₂O₅ and WO₃ total content of 20 to 45 mol %. Further, the optical glass A preferably includes a phosphate glass containing the above high-refractivity component(s).

Specifically, the optical glass A is preferably an optical glass containing, by mol %, 12 to 34% of P₂O₅, 0.2 to 15% of B₂O₃, 0 to 10% of TiO₂, 0 to 25% of Nb₂O₅, 0 to 40% of WO₃, the total content of TiO₂, Nb₂O₅ and WO₃ being 20 to 45%, 4 to 45% of at least one R₂O selected from Li₂O, Na₂O or K₂O and 0 to 30% (exclusive of 30%) of RO selected from BaO, ZnO or SrO, wherein the total content of the said components is at least 94%.

Further, the optical glass A is more preferably an optical glass containing, by mol %, 12 to 34% of P₂O₅, 0.2 to 15% of B₂O₃, the total content of P₂O₅ and B₂O₃ being 15 to 35%, 0 to 45% of WO₃, 0 to 25% of Nb₂O₅, 0 to 10% of TiO₂, the total content of TiO₂, Nb₂O₅ and WO₃ being 20 to 45%, 0 to 25% of BaO, 0 to 20% of ZnO, the total content of BaO and ZnO being less than 30%, 2 to 30% of Li₂O, 2 to 30% of Na₂O, 0 to 15% of K₂O, the total content of Li₂O, Na₂O and K₂O being 10 to 45%, 0 to 10% of CaO, 0 to 10% of SrO, 0 to 5% of Al₂O₃, 0 to 5% of Y₂O₃, 0 to 1% of Sb₂O₃ and 0 to 1% of As₂O₃, wherein the total content of the said components is at least 94%.

The optical constants that the above optical glass A can have, such as a refractive index (nd=1.70 or more) and an Abbe's number (νd=20 to 28.5), are very useful for an optical glass. However, a glass having these optical constants gives a lens that has low mechanical strength and is easily broken, so that the process of the present invention can be suitably employed.

The optical glass B includes an optical glass containing as a high-refractivity component, at least one member selected from La₂O₃ or Gd₂O₃ and having an La₂O₃ and Gd₂O₃ total content of 12 to 24 mol %, preferably 14 to 23 mol %. The optical glass B preferably includes an optical glass that is a borate glass (which means that the main network-forming component is boric acid) containing the above high-refractivity component(s).

Specifically, the optical glass B is preferably an optical glass containing, by mol %, 25 to 50% of B₂O₃, 2 to 20% of SiO₂, 5 to 22% of La₂O₃, 2 to 20% of Gd₂O₃, 15 to 29% of ZnO, 1 to 10% of Li₂O and 0.5 to 8% of ZrO₂, having a B₂O₃/SiO₂ molar ratio of from 2 to 5.5 and having an La₂O₃ and Gd₂O₃ total content of 12 to 24% and a ZnO and Li₂O total content of 25 to 30%.

The above optical glass B can be also advantageously used for a lens in a small-sized image sensing device. However, it has a high softening temperature and has a sag temperature of 600° C. or higher, and even if a mold release functional film is formed on a glass material before press-molding, the mold release functional film is liable to be deteriorated due to heat during pressing, so that a friction occurs in an interface between a mold and a lens, and the lens is liable to undergo breaking. The process of the present invention can be therefore suitably applied to the above optical glass B.

In the process of the present invention, a glass material made of the above optical glass and provided with a mold release functional film on a surface is introduced into a mold.

The glass material (glass preform) is pre-shaped to have a predetermined volume based on the shape of a lens to be obtained as an end product. A pre-shaped glass material having the form of a sphere, an oval, a disk, or the like can be used. A spherical or oval glass material free of any surface defect, which is pre-shaped from glass melt, is preferred.

A film having a mold releasing function (mold release functional film) is formed on the surface of the glass material. It is considered that when press-molding is carried out, cracking or breaking of a lens takes place mainly due to adhesion or friction between a molding surface and the lens. When a mold release functional film is formed, cracking and breaking can be decreased owing to improvements in mold releasability and slipperiness.

The mold release functional film is not specially limited so long as it can secure the slipperiness of a glass material on the molding surface, can prevent fusion and can improve mold releasability. The mold release functional film includes a metal- or carbon-containing film, and it is preferably a carbon-containing film.

The above carbon-containing film refers to a film containing carbon as a main component (50 at % to 100 at %) and includes a film containing C—C bond alone and a film containing C—C bond and C—H bond. For example, the carbon-containing film includes a carbon film that is a single-component film or a mixture film containing at least one member selected from amorphous and/or crystalline graphite or amorphous and/or crystalline diamond.

The carbon-containing film can be selected from a diamond-like carbon (DLC) film, a hydrogenated diamond-like carbon (DLC:H) film, a tetrahedral amorphous carbon (ta-C) film, a hydrogenated tetrahedral amorphous carbon (ta-C:H) film, an amorphous carbon (a-C) film, a hydrogenated amorphous carbon (a-C:H) film or a self-organized film.

The thickness of the mold release functional film can be determined as required depending upon intended mold releasability. It is preferably 0.1 to 500 nm, more preferably 0.1 to 100 nm, still more preferably 0.1 to 10 nm, particularly preferably 1 to 10 nm. A plurality of such mold release functional films may be stacked as required within the above thickness range.

The method of forming the mold release functional film is not critical. For example, the mold release functional film can be formed by a CVD method, a plasma CVD method such as a DC-plasma CVD method, an RF-plasma CVD method, a microwave plasma CVD method, an ECR-plasma CVD method, a photo-CVD method or a laser CVD method, a method of pyrolyzing an organic compound (e.g., hydrocarbon), an ionization vapor deposition method such as an ion plating method, a sputtering method, a vapor deposition method, an FCA method or a method of immersing a glass material in a coating solution for a self-assembled film. A method of pyrolyzing an organic compound (e.g., hydrocarbon) is preferred.

When the method of pyrolyzing a hydrocarbon is employed, a hydrocarbon such as acetylene, ethylene, butane, ethane, or the like is introduced into vacuum at a predetermined temperature to decompose the hydrocarbon into carbon and hydrogen, whereby a film can be formed. For example, the pressure for the pyrolysis is set at 10 to 200 Torr, preferably 50 to 200 Torr, and the temperature for the pyrolysis is determined as required depending upon the pyrolysis temperature of a hydrocarbon used and the softening temperature of a glass material. Generally, a film is formed under a condition of 250 to 600° C. The above pressure may be gradually increased or decreased or may be constant. When a film is formed by pyrolysis of acetylene, preferably, a film is formed at an acetylene partial pressure of 20 to 100 Torr and a reaction temperature of 400 to 550° C. Preferably, the hydrocarbon is fully dehydrated prior to its use depending upon its storage state. The film thickness can be controlled on the basis of the temperature during the pyrolysis, the pressure of a hydrocarbon introduced and the time period of the pyrolysis.

In the process of the present invention, the glass material having the above mold release functional film is required to have a surface free energy of 55 mJ/m² or less when it is press-molded.

The above surface free energy of a glass material when it is press-molded refers to a surface free energy of the glass material at the time of introduction when the glass material heated is introduced into a heated mold and immediately press-molded, and it refers to a surface free energy of a glass material at a time immediately before press-molding when the glass material is introduced into a mold, heated together with the mold and press-molded.

According to the present invention, the surface free energy is measured at room temperature after taking out a glass material in the above state. When a glass under heat is taken out, cooled to room temperature and measured for a surface free energy, there is substantially no change in the value of the surface free energy.

When a mold release functional film such as a carbon-containing film, or the like disappears or partly comes off under heat during a press-molding step to decrease the coating ratio on the glass material surface, it is considered that the surface free energy at room temperature increases as compared with the surface free energy after the film formation, and when the surface free energy value exceeds 55 mJ/m², a lens is liable to undergo cracking or breaking. The glass material when it is press-molded is therefore required to be coated with a mold release functional film so that it has a surface free energy of 55 mJ/m² or less. While a lower surface free energy is preferred, the surface free energy is preferably 45 to 55 mJ/m².

In the present invention, the surface free energy is measured by the following method. The premise is that the surface free energy (γ) of a solid or a liquid is represented by the following expression (1).
γ=γ^{d}+γ^{p} (1)
wherein γ^{d} is a dispersion force of a solid or liquid and γ^{p} is a polar interaction force of a solid or liquid.

That is, the expression (1) shows that the surface free energy of a solid or liquid can be represented by a total sum of the dispersion force and the polar interaction force thereof.

When the surface free energy (γₛ) of a solid is expressed by the expression (1), it follows as below.
γₛ=γₛ^{d}+γₛ^{p} (2)
wherein a subscript s represents a solid.

When the surface free energy (γ_{L}) of a liquid is expressed by the expression (1), it follows as below.
γ_{L}=γ_{L}^{d}+γ_{L}^{p} (3)
wherein a subscript L represents a liquid.

In the measurement, first, two liquids (water and diiodomethane) are used, an equal amount of each liquid is separately dropped on a solid (glass material having a mold release functional film), and each liquid is measured for a contact angle. Then, a surface free energy is calculated from the contact angles on the basis of an Owens-Wendt-Kaelble method (D. K. Owens, R. C. Wendt: J. Appl. Polymer Sci., 13, 1741 (1969)). An equation for the calculation is as follows.

$$1 / 2 \times {γ}_{L} \times ( 1 + cos θ ) = {( {γ}_{s}^{d} \times {γ}_{L}^{d} )}^{1 / 2} + {( {γ}_{s}^{p} \times {γ}_{L}^{p} )}^{1 / 2} \qquad ( 4 )$$

wherein θ represents a constant angle.

Surface free energies γ_{L} of two liquids (water and diiodomethane) are calculated beforehand from literature values of γ_{L}^{d} and γ_{L}^{P} of the two liquids shown in Table 1 below on the basis of the expression (3).

Values of γ_{L}^{d}, γ_{L}^{p} and γ_{L} of each of water and diiodomethane and measurement values of contact angles of water and diiodomethane are inserted into the expression (4), and obtained γₛ^{d} and γₛ^{p} are inserted into the expression (2), to determine a surface free energy γₛ of a solid (glass material having a mold release functional film).

TABLE 1

| | γ_{L}^{d} | γ_{L}^{p} | γ_{L} |
|---|---|---|---|
| Water | 21.8 | 51 | 72.8 |
| Diiodomethane | 50.8 | 0 | 50.8 |

In the process of the present invention, a glass material having the above surface free energy is introduced into a mold and press-molded, to produce a glass molded lens. The press-molding is a method in which a glass material is press-molded with a mold having a precision-processed molding surface, and the method enables the production of an optical glass element having high form accuracy and surface accuracy at a low cost.

Before a glass material having a mold release functional film on a surface is introduced into a mold, preferably, the glass material is pre-heated to a temperature equivalent to, or higher than, the temperature of the mold to bring the glass material into a softened state. The step of the preheating is preferably carried out outside the mold and in a heating furnace having a sufficient capacity. When the preheated glass material in a softened state is introduced into a mold, a surface defect may be caused due to a contact between the glass material surface and a tool, which may affect the surface accuracy or appearance of a lens. When the glass material is introduced, therefore, it is preferred to use a tool that can transport the glass material in a state where it is floated with a gas that is being injected.

The glass material is preheated at a temperature at which it comes to have a glass viscosity sufficient for press-molding and at which there comes to be substantially no difference between the temperature inside the glass material and the temperature outside the glass material.

The glass material is pre-heated preferably in a non-oxidizing atmosphere, and it is pre-heated up to a temperature corresponding to a viscosity of 10^{6.5} to 10^{8.5} poise as a glass viscosity, more preferably, up to a temperature corresponding to a viscosity of 10^{7.0} to 10^{8.0} poise as a glass viscosity. Although differing depending upon a glass composition (glass species) used, the heating temperature is preferably in the range of approximately 550 to 720° C.

The time period required for the pre-heating differs depending upon the volume of a glass material. For example, the temperature corresponding to a viscosity of 10^{6.5} to 10^{8.5} poise as a glass viscosity is 600 to 700° C., and when the pre-heating time period exceeds 150 seconds, the mold release functional film such as a carbon-containing film, or the like on a glass material surface disappears, is altered or partly comes off, and the releasability and slipperiness on the glass material surface may be removed, which may easily cause cracking or breaking. On the other hand, when the above pre-heating time period is less than 60 seconds, no sufficient viscosity for press-molding may be obtained.

Therefore, the pre-heating time period is adjusted preferably to 150 seconds or less, more preferably to at least 60 seconds but not more than 150 seconds.

A glass material introduced into a mold is subjected to press-molding in a softened state produced by the pre-heating. The mold is heated preferably to a temperature corresponding to a viscosity of 10^{7.5} to 10^{10.0} poise as a glass viscosity, more preferably, to a temperature corresponding to a viscosity of 10^{8.0} to 10^{9.0} poise as a glass viscosity. Preferably, the temperature difference between an upper mold member and a lower mold member of the mold is 10° C. or less, and more preferably, the upper mold member and the lower mold member have the same temperature.

Further, preferably, the mold has a temperature lower than the temperature of a glass material. That is because a molding cycle time can be decreased and the lifetime of the mold can be increased when the mold has a lower temperature.

On the other hand, when the temperature for heating a glass material is increased to excess for making the temperature of the mold lower, the deterioration of the mold release functional film such as a carbon-containing film, or the like is liable to proceed easily, and a lens may be caused to undergo cracking or breaking. Particularly, when the glass material has a form or is formed of a glass species that is liable to cause cracking or breaking, it is preferred to adjust the glass material and the mold to the same temperature.

The mold can be selected, for example, from a mold made of silicon carbide, silicon, silicon nitride, tungsten carbide, aluminum oxide or cermet of titanium carbide, or a mold prepared by coating a mold release film having a mold releasing function on the surface of the above mold. The mold release film can be selected from a metal coating made of ceramic of a refractory metal, a noble metal alloy, carbide, nitride, borate, oxide or the like, or it can be selected from carbon coatings such as a diamond-like carbon (DLC) film, a hydrogenated diamond-like carbon (DLC:H) film, a tetrahedral amorphous carbon (ta-C) film, a hydrogenated tetrahedral amorphous carbon (ta-C:H) film, an amorphous carbon (a-C) film and a hydrogenated amorphous carbon (a-C:H) film.

Particularly, it is preferred to use a mold prepared by forming a base material for a mold from silicon carbide by a CVD method, processing the base material so that it has a finish form, and forming a mold release film.

The mold release film preferably has a thickness of 0.1 to 1,000 nm, more preferably 10 to 500 nm. A plurality of such mold release films may be stacked so long as the total thickness is within the above range.

The mold release film is formed on a molding surface by a plasma CVD method such as a DC-plasma CVD method, an RF-plasma CVD method, a microwave plasma CVD method, an ECR-plasma CVD method, a photo-CVD method or a laser CVD method, an ionization vapor deposition method such as an ion plating method, a sputtering method or a vapor deposition method.

When the mold release functional film on a glass material surface is a film containing carbon or when the mold release film present on the molding surface of a mold is a carbon-containing film, these films may disappear, may be altered or may comes off due to the pre-heating of the glass material or the heating in the mold. Particularly, it is considered that since the mold release functional film on a glass material surface has a thickness of approximately 100 nm or less, the mold release functional film is liable to be deteriorated, and a lens is liable to undergo cracking or breaking.

The press-molding is therefore preferably carried out in a non-oxidizing atmosphere. The non-oxidizing atmosphere includes, for example, a nitrogen atmosphere and a nitrogen atmosphere containing 0.2 to 0.5 vol % of hydrogen.

Immediately after a glass material is introduced into a mold, it is press-molded. The press-molding is carried out, for example, in a manner in which the lower mold member of the mold is moved upward, or the upper mold member is moved downward, to apply a predetermined load on the glass material so that the glass material is pressed fully.

In the press-molding, preferably, the pressing load applied to the glass is 500 kg/cm² or less. Further, when the glass material has a diameter D1 of 7.0 mm or more for pressing, the pressing load is preferably adjusted to 150 to 250 kg/cm².

After press-molded, the glass (lens) is cooled while it is in contact with the mold, and after the glass is cooled to a predetermined temperature, the lens is released from the mold. In this case, the cooling rate is preferably adjusted to 1 to 3° C./second. When the lens is released from the mold at a temperature higher than a temperature corresponding to a glass viscosity of 10^{11.0} poise, the lens may come into a state where it is attached to the upper mold member, and the lens cannot be taken out smoothly. Further, when the temperature for releasing the lens is lower than a temperature corresponding to a glass viscosity of 10^{15.0} poise, the production efficiency is low. Therefore, the releasing temperature is preferably a temperature corresponding to a glass viscosity of 10^{11.0} poise to 10^{15.0} poise, more preferably a temperature corresponding to a glass viscosity of 10^{12.0} poise to 10^{13.0} poise.

As described above, the process of the present invention is carried out by a press-molding method, and according to the process of the present invention, thin lenses can be easily and stably produced at high yields while preventing cracking and breaking of the lenses.

A glass molded lens obtained by the process of the present invention has a biconvex form having a central thickness of 1.2 to 1.8 mm and has a diameter of 5 to 20 mm after produced by press-molding.

The glass molded lens preferably has a central thickness of 1.4 to 1.6 mm. In the present invention, the central thickness refers to a thickness of the thickest portion of a lens, that is, a thickness of the optical axis portion of a lens.

The glass molded lens preferably has a diameter of 8 to 15 mm after produced by press-molding. The diameter after production by press-molding refers to a diameter of a lens obtained immediately after a glass material is press-molded (before post-processing such as processing for centering and edging is carried out). When no such post processing is carried out after the press-molding, the diameter after produced by press-molding is a final diameter of a glass molded lens.

In the glass molded lens of the present invention, the thickness of a circumference of the lens is preferably 0.1 to 0.7 mm, more preferably 0.2 to 0.5 mm. The above circumference of a lens refers to a circumferential edge portion of the lens.

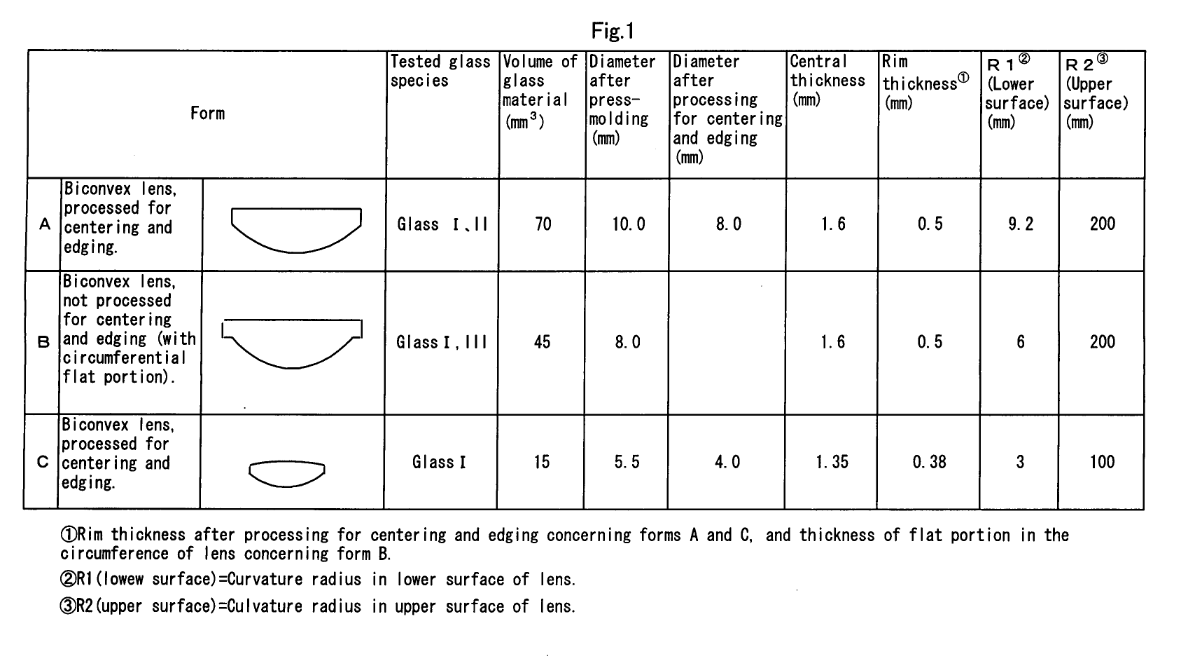

The above lens includes a glass molded lens having an annular flat portion having a thickness of 0.1 to 0.7 mm, preferably 0.2 to 0.5 mm in the circumference thereof. In this lens, the circumferential portion of the lens has no curvature and has a flange-shaped flat portion, and specifically, forms shown as B of FIG. 1 to be described later are included.

Particularly, the glass molded lens is preferably a lens satisfying 8≦D1/d1≦22 in which d1 is a thickness of a circumferential flat portion and D1 is a diameter of a lens produced after press-molding, more preferably a lens satisfying 10≦D1/d1≦16.

Further, the glass molded lens of the present invention includes a glass molded lens having a rim thickness of 0.1 to 0.7 mm, preferably 0.2 to 0.5 mm. The above rim thickness refers to a thickness of the circumference of a lens that has been processed for centering and edging, or a rim thickness of a lens that is obtained immediately after the press-molding when the above processing is not carried out.

Specifically, forms shown as A or C in FIG. 1 to be described later are included. A lens satisfying 10≦D2/d2≦16 is preferred, in which d2 is a circumferential thickness and D2 is a diameter of a lens after the processing for centering and edging is carried out. The glass molded lens preferably has at least one surface having a curvature radius of 80 mm or more, more preferably has a surface having a curvature radius of 100 mm or more. When a lens has such a large curvature radius, the lens is liable to undergo breaking due to adhesion of a mold and the lens in the interface thereof. According to the process of the present invention, however, lenses having high accuracy can be stably produced by molding. The curvature radius of the other surface is not limited, and various curvature radius can be provided.

In the present invention, there can be obtained a glass molded lens having a thickness accuracy of within 20 μm and a surface accuracy of one Newton's ring or less with regard to both astigma and irregularities.

The field of use of a glass molded lens obtained by the process of the present invention is not specially limited. The glass molded lens obtained by the process of the present invention can be suitably used as an aspherical glass lens for use in an optical system of a downsized image-sensing device or in an optical system mounted in a mobile device.

### EXAMPLES

The present invention will be explained more in detail hereinafter with reference to Examples, while the present invention shall not be limited by these Examples.

In Examples and Comparative Examples, each glass viscosity was determined by the following method.

That is, optical glasses shown in glasses I to III in Table 2 to be described later were measured for viscosities at temperatures with a co-axial double-cylindrical rotation viscometer (high-temperature viscosity measuring apparatus, RHEOTRONIC, supplied by Tokyo Kogyo K.K.) according to a measurement method defined under JIS Z 8803, and relational expressions of temperature and viscosities were prepared.

When glass materials were molded, viscosities of the glasses were calculated from the basis of pre-heating temperatures of the glass materials and temperatures of a mold on the basis of the relational expressions obtained beforehand.

### Example 1

A high-refractivity high-dispersion phosphate optical glass having a composition shown as glass I in Table 2 (refractive index (nd): 1.82114, Abbe's number (νd): 24.1, glass transition temperature (Tg): 475° C., sag temperature (Ts): 525° C.) was dropped in a molten state and pre-shaped in the form of an oval, to prepare a glass material.

Then, the glass material was placed in a reactor, acetylene gas was introduced into the reactor to bring it into contact with the glass material, and a carbon-containing film as a mold release functional film was formed on the glass material surface by pyrolysis of acetylene. In this case, the acetylene in the reactor had a partial pressure of 30 torr, and the temperature inside the reactor was 480° C.

The glass material having the above mold release functional film was placed on a floating tool and transported into a heating furnace while it was slightly floated with a gas current. The glass material was heated to a temperature (600° C.) corresponding to a glass viscosity of 10^{7.0} poise for 130 seconds, and dropped and introduced into a mold heated to a temperature (580° C.) corresponding to a glass viscosity of 10^{8.0} poise.

When the surface free energy of surface of the glass material being dropped and introduced into the mold was determined by measuring water and diiodomethane for contact angles according to an Owens-Wendt-Kaelble method, it was 53.5 mJ/m².

The mold used above had been prepared by forming a mold base material made of SiC by a CVD method, precision-processing a molding surface having an aspherical form and then further stacking a carbon film formed by an ion-plating method and a carbon film formed by a sputtering method on the molding surface. The press-molding was carried out in a nitrogen atmosphere containing 0.5 vol % of hydrogen under a pressure of 160 kg/cm² for 30 seconds. After the pressing, the pressure was removed, and a press-molded product was cooled to a temperature (470° C.) corresponding to a glass viscosity of 10^{13.0} poise in a state where an upper mold member and a lower mold member were in contact. The glass molded product was taken out of a pressing apparatus, to give a lens. When 3,000 lenses were produced in the above manner by continuous press molding, no lenses underwent cracking or breaking, and they were stably produced.

The thus-obtained lenses were biconvex lenses having a central thickness of 1.6 mm and a diameter of 10 mm after production by press molding. They had a thickness accuracy of within 20 μm and a surface accuracy of one Newton's ring or less with regard to astigma and irregularities. These lenses were processed for centering and edging to give optical lenses having a lens diameter of 8.0 mm (diameter after processing for centering and edging) and a circumferential thickness of 0.5 mm and having a form shown as A in FIG. 1. These optical lenses had a D2/d2 ratio of 16.0, in which D2 was a diameter after processing for centering and edging and d2 was a rim thickness.

### Comparative Example 1

Optical lenses having a form shown as A in FIG. 1 were produced in the same manner as in Example 1 except that the time period for pre-heating the glass materials was changed to 160 seconds.

The glass materials had a surface free energy of 55.3 mJ/m² when they were press-molded, and 15% of the optical lenses obtained by the press-molding were cracked or broken.

### Example 2

Optical lenses having a form shown as A in FIG. 1 were produced in the same manner as in Example 1 except that the optical glass was replaced with an optical glass having a composition shown in glass II in Table 2 and that the conditions were changed as shown in Table 3.

The glass materials had a surface free energy of 53.2 mJ/m² when they were press-molded, and the optical lenses obtained by the press-molding were free of cracking and breaking and were stably produced. Further, they had a thickness accuracy of within 20 μm and a surface accuracy of one Newton's ring or less with regard to astigma and irregularities.

### Example 3

Using a high-refractivity high-dispersion optical glass having a composition shown as glass I in Table 2, optical lenses having a form shown as B in FIG. 1 were produced in the same manner as in Example 1 except that the conditions were changed as shown in Table 3. After press-molded, these optical lenses were not subjected to the processing for centering and edging. The glass materials had a surface free energy of 52.7 mJ/m² when they were press-molded, and the optical lenses obtained by the press-molding were free of cracking and breaking and were stably produced.

The thus-obtained optical lenses had a central thickness of 1.6 mm and a diameter of 8.0 mm after press-molded and had a 0.5 mm thick annular flat portion in the circumference thereof. These optical lenses had a D1/d1 ratio of 16.0, in which D1 was a diameter after press-molding and d1 was a thickness of the flat portion. Further, they had a thickness accuracy of within 20 μm and a surface accuracy of one Newton's ring or less with regard to astigma and irregularities.

### Example 4

Using a high-refractivity high-dispersion optical glass having a composition shown as glass I in Table 2, optical lenses having a biconvex form and having a form shown as C in FIG. 1 were produced in the same manner as in Example 1 except that the conditions were changed as shown in Table 3.

The glass materials had a surface free energy of 52.9 mJ/m² when they were press-molded, and the optical lenses obtained by the press-molding were free of cracking and breaking and were stably produced. The thus-obtained lenses were biconvex lenses having a central thickness of 1.35 mm and a diameter of 5.5 mm (after the press-molding), and they had a thickness accuracy of within 20 μm and a surface accuracy of one Newton's ring or less with regard to astigma and irregularities. These lenses were processed for centering and edging, to give lenses having a lens diameter of 4.0 mm and a rim thickness of 0.38 mm and having a form shown as C in FIG. 1. These optical lenses had a D2/d2 ratio of 10.5, in which D2 was a diameter after the processing for centering and edging and d2 was a rim thickness.

### Example 5

Optical lenses having a form shown as B in FIG. 1 were produced in the same manner as in Example 1 except that the optical glass was replaced with a high-refractivity optical glass having a composition shown in glass III in Table 2 and that the conditions were changed as shown in Table 3. After press-molded, these optical lenses were not subjected to the process for centering and edging. The glass materials had a surface free energy of 52.7 mJ/m² when they were press-molded, and the optical lenses obtained by the press-molding were free of cracking and breaking and were stably produced.

The thus-obtained optical lenses were optical lenses having a central thickness of 1.6 mm and a diameter of 8.0 mm after press-molding and having a 0.5 mm thick annular flat portion in the circumference thereof. These optical lenses had a D1/d1 ratio of 16.0, in which D1 was a diameter after press-molding and d1 was a thickness of the flat portion. Further, they had a thickness accuracy of within 20 μm and a surface accuracy of one Newton's ring or less with regard to astigma and irregularities.

### Comparative Example 2

Optical lenses having a form shown as B in FIG. 1 were produced in the same manner as Example 5 except that the time period for pre-heating the glass materials was changed to 160 seconds.

The glass materials had a surface free energy of 57.8 mJ/m² when they were press-molded, and 50% of the optical lenses obtained by the press-molding were cracked or broken.

TABLE 2

| Glass composition | | | |
|---|---|---|---|
| (mol %) | Glass I | Glass II | Glass III |
| P₂O₅ | 24.0 | | |
| B₂O₃ | 3.0 | 36.8 | 49.6 |
| Si₂O | | 12.8 | 6.9 |
| TiO₂ | 6.0 | | |
| Nb₂O₅ | 18.0 | | |
| WO₃ | 8.0 | | |
| La₂O₃ | | 8.0 | 9.5 |
| Gd₂O₃ | | 8.0 | 9.5 |
| Li₂O | 21.0 | 5.6 | 3.0 |
| Na₂O | 12.0 | | |
| K₂O | 2.0 | | |
| BaO | 3.0 | | |
| ZnO | 3.0 | 22.4 | 15.5 |
| ZrO₂ | | 4.8 | 5.2 |
| Ta₂O₅ | | 1.6 | 0.9 |
| (Glass Properties) | | | |
| Refractive index: nd | 1.82114 | 1.77377 | 1.76802 |
| Abbe's number: νd | 24.1 | 47.2 | 49.2 |
| Glass transition | 475 | 570 | 605 |
| temperature: Tg (° C.) | | | |
| Sag temperature (° C.) | 525 | 615 | 645 |

TABLE 3

| | | | | | Glass |
|---|---|---|---|---|---|
| | | | | | viscosity |
| | | | | | correspond- |
| | | | Time | Tempera- | ing to |
| | | | period | ture for | temperature |
| | | | for pre- | pre- | for pre- |
| | | | heating | heating | heating |
| | | | glass | glass | glass |
| | Glass | Form | material | material | material |
| | species | *1 | (second) | (° C.) | (poise) |
| Ex. 1 | Glass I | A | 130 | 600 | 10^{7.0} |
| Ex. 2 | Glass II | A | 110 | 690 | 10^{7.5} |
| Ex. 3 | Glass I | B | 95 | 600 | 10^{7.0} |
| Ex. 4 | Glass I | C | 90 | 580 | 10^{8.3} |
| Ex. 5 | Glass III | B | 95 | 700 | 10^{7.2} |
| CEx. 1 | Glass I | A | 160 | 600 | 10^{7.0} |
| CEx. 2 | Glass III | B | 160 | 700 | 10^{7.2} |
| | | | Glass | | |
| | | | voscosity | Pressure | Tempera- |
| | Surface | Mold | correspond- | for | ture for |
| | free | tempera- | ing to mold | press- | release |
| | energy | ture | temperature | molding | from mold |
| | (mJ/m²) | (° C.) | (poise) | (kg/cm²) | (° C.) |
| Ex. 1 | 53.5 | 580 | 10^{8.0} | 160 | 470 |
| Ex. 2 | 53.2 | 680 | 10^{8.0} | 160 | 575 |
| Ex. 3 | 52.7 | 580 | 10^{8.0} | 220 | 495 |
| Ex. 4 | 52.9 | 560 | 10^{9.0} | 420 | 500 |
| Ex. 5 | 52.7 | 690 | 10^{7.5} | 220 | 610 |
| CEx. 1 | 55.3 | 580 | 10^{8.0} | 160 | 470 |
| CEx. 2 | 57.8 | 690 | 10^{7.5} | 220 | 610 |

| | Cracking, | Rim thickness | |
|---|---|---|---|
| | breaking | (mm) | D/d *2 |
| Ex. 1 | 0% | 0.5 | 16.0 |
| Ex. 2 | 0% | 0.5 | 16.0 |
| Ex. 3 | 0% | 0.5 | 16.0 |
| Ex. 4 | 0% | 0.38 | 10.5 |
| Ex. 5 | 0% | 0.5 | 16.0 |
| CEx. 1 | 15% | 0.5 | 16.0 |
| CEx. 2 | 50% | 0.5 | 16.0 |

Ex. = Example,
CEx. = Comparative Example
*1: Forms A, B and C are shown in FIG. 1.
*2: D/d = Diameter after processing for centering and edging/rim thickness concerning the forms A and C.
D/d = Diameter after press-molding/thickness of flat portion concerning the form B.

### INDUSTRIAL UTILITY

According to the process of the present invention, a small-sized glass molded lens that is made of a high-refractivity optical glass and that has a small central thickness and a biconvex form can be produced without causing cracking or breaking.

1. A process for producing a glass molded lens, which comprises the steps of introducing a glass material made of an optical glass having a refractive index nd of 1.70 or more and provided with a mold release functional film on a surface into a mold and press-molding the glass material to obtain the glass molded lens, the glass material having a surface free energy of 55 mJ/m² or less when it is press-molded.

2. The process of claim 1, wherein the glass material is pre-heated in a non-oxidizing atmosphere up to a temperature corresponding to a viscosity of 10^{6.5} to 10^{8.5} poise as a glass viscosity before the glass material is introduced into the mold.

3. The process of claim 2, wherein the press-molding is carried out in a non-oxidizing atmosphere in the mold that is heated up to a temperature corresponding to a viscosity of 10^{7.5} to 10^{10.0} poise as a glass viscosity.

4. The process of claim 1, wherein the optical glass contains at least one member selected from TiO₂, Nb₂O₅ or WO₃ and has a TiO₂, Nb₂O₅ and WO₃ total content of 20 to 45 mol %.

5. The process of claims 1, wherein the optical glass is a phosphate glass.

6. The process of claim 1, wherein the optical glass contains at least one member selected from La₂O₃ or Gd₂O₃ and has a La₂O₃ and Gd₂O₃ total content of 12 to 24 mol %.

7. The process of claim 1, wherein the glass molded lens has a biconvex form having a central thickness of 1.2 to 1.8 mm and has a diameter of 5 to 20 mm after produced by press-molding.

8. The process of claim 1, wherein the glass molded lens has an annular flat portion in a circumference thereof.

9. The process of claim 1, wherein the glass molded lens has a rim thickness of 0.1 to 0.7 mm.
